(19) United States
(12) Patent Application Publication
(10) Pub. No.: US 2024/0429553 A1
(43) Pub. Date: Dec. 26, 2024

(54) LASER-WELDING OF EXTERNAL TABS OF ELECTRODES TO INTERNAL TERMINALS OF BATTERY CELLS

(71) Applicant: GM GLOBAL TECHNOLOGY OPERATIONS LLC, Detroit, MI (US)

(72) Inventors: Masoud MOHAMMADPOUR, Novi, MI (US); Junjie MA, Novi, MI (US); Teresa Jean RINKER, Royal Oak, MI (US); Blair E. CARLSON, Ann Arbor, MI (US); Jennifer Therese BRACEY, Holly, MI (US)

(21) Appl. No.: 18/337,916

(22) Filed: Jun. 20, 2023

(51) Int. Cl. H01M 50/30; B23K 26/26; H01M 50/46; H01M 50/536

(52) U.S. Cl. CPC H01M 50/394; B23K 26/26; H01M 50/46; H01M 50/536

(57) ABSTRACT

A method for manufacturing a battery cell includes providing a stack including C cathode electrodes each including a cathode current collector, a cathode active layer, and an external tab extending from the cathode current collector, A anode electrodes including an anode current collector, an anode active layer, and an external tab extending from the anode current collector, and S separators. The method includes providing a terminal including a first portion connected to a second portion at a predetermined angle less than or equal to 100°; positioning external tabs of one of the A anode electrodes and the C cathode electrodes in contact with one of an inner surface and an outer surface of the first portion of the terminal; and laser welding ends of the external tabs to the one of an inner surface and an outer surface of the first portion of the terminal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to external tabs of electrodes that are laser-welded to internal terminals of battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A method for manufacturing a battery cell includes providing a stack including C cathode electrodes each including a cathode current collector, a cathode active layer arranged on the cathode current collector, and an external tab extending from the cathode current collector, A anode electrodes including an anode current collector, an anode active layer arranged on the anode current collector, and an external tab extending from the anode current collector, and S separators, where C, S and A are integers greater than one. The method includes providing a terminal including a first portion connected to a second portion at a predetermined angle less than or equal to 100°; positioning external tabs of one of the A anode electrodes and the C cathode electrodes in contact with one of an inner surface and an outer surface of the first portion of the terminal; and laser welding ends of the external tabs to the one of an inner surface and an outer surface of the first portion of the terminal.

In other features, the predetermined angle is in a range from 80° to 100°. The predetermined angle is in a range from 15° to 75°. The predetermined angle is in a range from 35° to 55°. The first portion of the terminal has a height that is greater than or equal to a height of the stack.

In other features, the method includes arranging a gas relief channel on one of the second portion and a supporting surface arranged below the stack and the terminal. The gas relief channel is arranged below the external tabs of the one of the A anode electrodes and the C cathode electrodes. The external tabs of the one of the A anode electrodes and the C cathode electrodes are laser welded to an outer surface of the terminal. The external tabs of the one of the A anode electrodes and the C cathode electrodes are laser welded to an inner surface of the terminal.

In other features, the second portion is “U”-shaped, and the terminal further includes a third portion extending from the second portion. The second portion includes a gas relief channel. The method includes cutting the external tabs of the one of the A anode electrodes and the C cathode electrodes at a predetermined angle prior to laser welding. The predetermined angle is within +/−10° of an angle formed between the first portion and the second portion of the terminal.

In other features, the laser welding is performed through the first portion of the terminal. The laser welding forms a butt weld between the terminal and the external tabs of the one of the A anode electrodes and the C cathode electrodes. The method includes pressing the external tabs of the one of the A anode electrodes and the C cathode electrodes against the terminal prior to laser welding. The method includes pressing the external tabs of the one of the A anode electrodes and the C cathode electrodes against the terminal and clamping the stack to at least one of the terminal and a supporting surface during laser welding.

A battery cell includes a stack including C cathode electrodes each including a cathode current collector, a cathode active layer arranged on the cathode current collector, and an external tab extending from the cathode current collector, A anode electrodes including an anode current collector, an anode active layer arranged on the anode current collector, and an external tab extending from the anode current collector, and S separators, where C, S and A are integers greater than one. The battery cell includes a terminal including a first portion connected to a second portion at a predetermined angle less than or equal to 100°. The external tabs of one of the A anode electrode and the C cathode electrodes are laser welded to one of an inner surface and an outer surface of the first portion of the terminal.

In other features, the predetermined angle is in a range from 15° to 100°.

In other features, a gas relief channel is arranged on the second portion. The gas relief channel is arranged below the external tabs of the one of the A anode electrodes and the C cathode electrodes. The external tabs of the one of the A anode electrodes and the C cathode electrodes are cut at a predetermined angle, and the predetermined angle is within +/−10° of an angle formed between the first portion and the second portion of the terminal.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side cross sectional view of an example of a battery cell including cathode electrodes, anode electrodes, and separators according to the present disclosure;

FIG. 1B is a side view of an example of a pouch battery cell according to the present disclosure;

FIG. 1C is a perspective view of an example of a prismatic battery according to the present disclosure;

FIG. 1D is a side cross sectional view of an example of internal and external terminals of a prismatic battery cell according to the present disclosure;

FIGS. 2A to 2C are perspective views of examples of stacks of electrodes arranged on and laser-welded to an internal terminal according to the present disclosure;

FIGS. 3A to 3B are perspective views of other examples of stacks of electrodes arranged on and laser-welded to an internal terminal according to the present disclosure;

FIGS. 4A to 4B are perspective views of other examples of stacks of electrodes arranged on and laser-welded to an internal terminal with a gas relief channel according to the present disclosure;

FIGS. 5A to 5E are perspective views of other examples of stacks of electrodes arranged on and laser-welded to an internal terminal including a first portion forming an acute angle relative to a second portion according to the present disclosure;

FIG. 6 is a side view of an example of a stack of electrodes trimmed at an acute angle at one end thereof according to the present disclosure; and

FIG. 7 is a side view of an example of an internal terminal with a first portion forming a predetermined angle relative to a second portion of the internal terminal and a stack of electrodes trimmed at approximately the same angle according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

The present disclosure addresses quality issues of welds between external tabs extending from current collectors of anode and/or cathode electrodes and terminals of a battery cell. In some examples, the battery cell comprises a pouch battery cell including terminals that are laser welded to the external tabs and that extend through the pouch enclosure. In some examples, internal terminals of the battery cell are in contact with external terminals of the battery cell in prismatic battery cells. In other words, the external terminals are in contact with the internal terminals that are laser welded to the external tabs of the cathode electrodes and/or anode electrodes. As can be appreciated, separate internal terminals are used to connect to the cathode and anode electrodes.

When welding multiple layers of external tabs (e.g., external tabs extending from current collectors made of foil) in a lap joint, the weld may be porous and detachments may occur at a boundary of fusion. The present disclosure relates to joining of the external tabs of the current collectors of anode and/or cathode electrodes to the internal terminals using laser welding with improved weld quality. In some examples, laser welding is performed without requiring the use of ultrasonic welding.

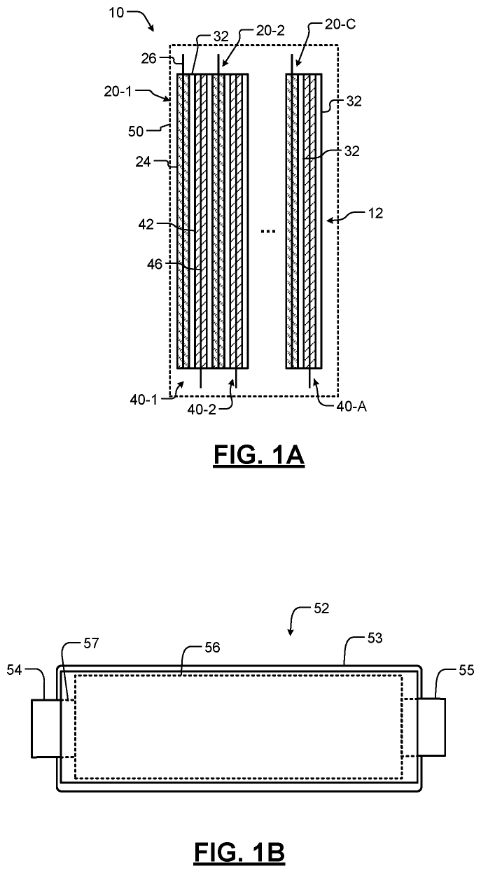

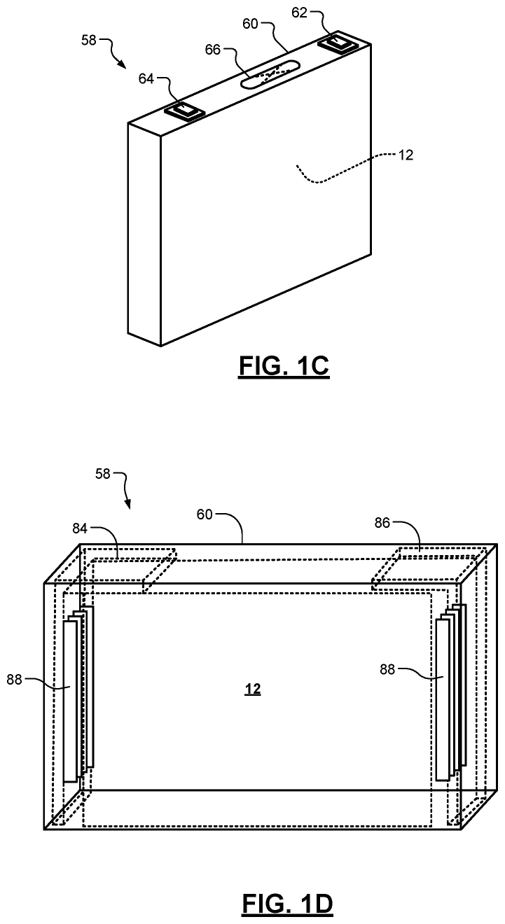

Referring now to FIG. 1A, a battery cell 10 includes C cathode electrodes 20, A anode electrodes 40, and S separators 32 arranged in a predetermined sequence in a stack 12 arranged in an enclosure 50. The cathode electrodes 20-1, 20-2, . . . , and 20-C (where C is an integer greater than one) include cathode active layers 24 arranged on one or both sides of cathode current collectors 26. The anode electrodes 40-1, 40-2, . . . , and 40-A (where A is an integer greater than one) include anode active layers 42 arranged on one or both sides of the anode current collectors 46. The external tabs correspond to portions of the current collectors that extend beyond the active material layers.

In some examples, the anode active layers 42 and/or the cathode active layers 24 comprise coatings including one or more active materials, one or more conductive fillers/additives, and/or one or more binder materials. In some examples, the battery cells and/or electrodes are manufactured by applying a slurry to coat the current collectors in a roll-to-roll manufacturing process. In some examples, the cathode current collectors 26 and the anode current collectors 46 comprise a foil layer. In some examples, the current collectors are made of one or more materials selected from a group consisting of copper, stainless steel, brass, bronze, zinc, aluminum, and alloys thereof.

Referring now to FIG. 1B, a pouch battery cell 52 includes a pouch enclosure 53 including a stack 56. As will be described further below, external tabs 57 of the anode and cathode electrodes are laser welded to terminals 54 and 55, respectively, that extend through the pouch enclosure 53.

Referring now to FIG. 1C, a prismatic battery cell 58 includes an enclosure 60. While a prismatic battery cell is shown for purposes of illustration, other battery cell form factors can be used. In some examples, the enclosure 60 has rectangular cross-sections in x-, y- and z-axis planes. The prismatic battery cell 58 includes external terminals 62 and 64 and a vent cap 66. The stack 12 of the C cathode electrodes 20, the A anode electrodes 40, and the S separators 32 is arranged in the enclosure 60. As will be described further below, external tabs of the anode current collectors and/or the cathode current collectors are laser-welded to the corresponding one of the internal terminals. The internal terminals are arranged in contact with the external terminals 62 and 64 of the battery cell 10.

Referring now to FIG. 1D, internal terminals 84 and 86 are shown in the enclosure 60. The stack 12 of the A anode electrodes and the C cathode electrodes include external tabs 88 that are laser welded to the internal terminals 84 and 86, respectively, as will be described further below.

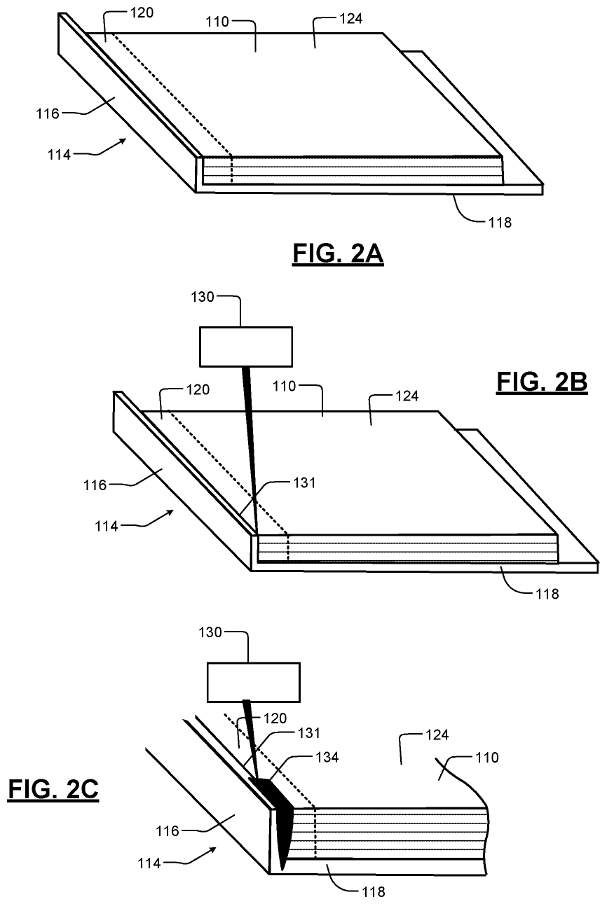

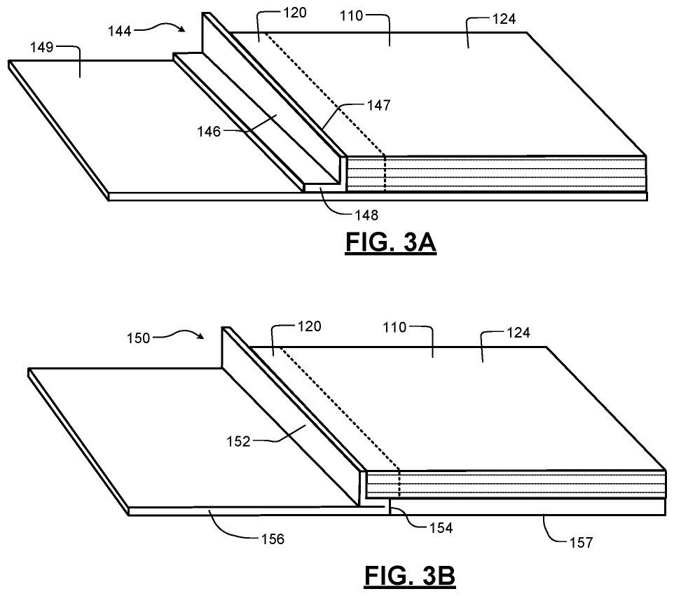

Referring now to FIGS. 2A to 2C, an example of a method for attaching external tabs of the anode and/or cathode electrodes to internal terminals is shown. In FIG. 2A, a stack 110 (e.g., the A anode electrodes, the C cathode electrodes, and the S separators) is arranged in an abutting position relative to an internal terminal 114. External tabs 120 of the anode and/or cathode electrode are laser-welded to the internal terminal 114.

In some examples, the internal terminal 114 includes a first portion 116 and a second portion 118. In some examples, the first portion 116 is attached to the second portion 118 at a predetermined angle in a range from 80° to 100° (e.g., 90°). In some examples, the first portion 116 has a height that extends approximately transverse to a longitudinal direction of the second portion 118. In some examples, the height of the first portion 116 is greater than or equal to a height of the stack 110. The longitudinal length of the second portion can be longer or shorter than a length of the stack 110.

In some examples, the A anode electrodes or the C cathode electrodes in the stack 110 include one or more external tabs 120 (extending from the current collectors beyond an active material layer 124). In some examples, the external tabs 120 extend the entire width of the electrodes, the current collectors, and/or the internal terminal. In other examples, the external tabs 120 extend only partially along the width of the electrodes, the current collectors, and/or the internal terminal. In other examples, each current collector includes two or more external tabs that are split, or notched (e.g., spaced by a gap) and separately laser welded to the internal terminals to provide a redundant connection as described below.

In FIGS. 2B and 2C, a laser 130 is used to weld the external tabs 120 to an inner surface 131 of the first portion 116. In FIG. 2C, a butt weld 134 is created between the external tabs 120 and the inner surface 131 of the first portion 116.

Referring now to FIGS. 3A to 3B, the internal terminals can have other configurations and/or the external tabs 120 can be welded to the internal terminals in other orientations. In FIG. 3A, an internal terminal 144 includes a first portion 146 and a second portion 148. In some examples, the first portion 146 is attached to the second portion 148 at a predetermined angle in a range from 80° to 100° (e.g., 90°). In some examples, the first portion 146 has a height that is greater than or equal to a height of the stack 110. The longitudinal length of the second portion 148 can be longer or shorter than a length of the stack 110.

In FIG. 3A, the internal terminal 144 is arranged on a support surface 149 with the second portion 148 extending away from the stack 110. The external tabs 120 are arranged in contact with an outer surface 147 of the first portion 146. A laser is used to butt weld the external tabs 120 to the outer surface 147 of the first portion 146.

In FIG. 3B, an internal terminal 150 includes a first portion 152, a second portion 154, and a third portion 156. In some examples, the first portion 152 is attached to the second portion 154 at a predetermined angle in a range from 80° to 100° (e.g., 90°). The second portion 154 is “U”-shaped. In other words, the second portion 154 is folded back upon itself to create a “U”-shape with a minimal gap or no gap between sides thereof. One end of the second portion 154 extends from the first portion 152. The third portion 156 extends from the other end of the second portion 154. The first portion 152 forms an angle relative to one side of the second portion 154. The second portion 154 extends a first predetermined distance, bends 180°, extends a second predetermined distance, and is connected to the third portion 156. The longitudinal length of the third portion 156 can be longer or shorter than a length of the stack 110. In some examples, the stack 110 can be arranged on a supporting surface 157 during laser welding.

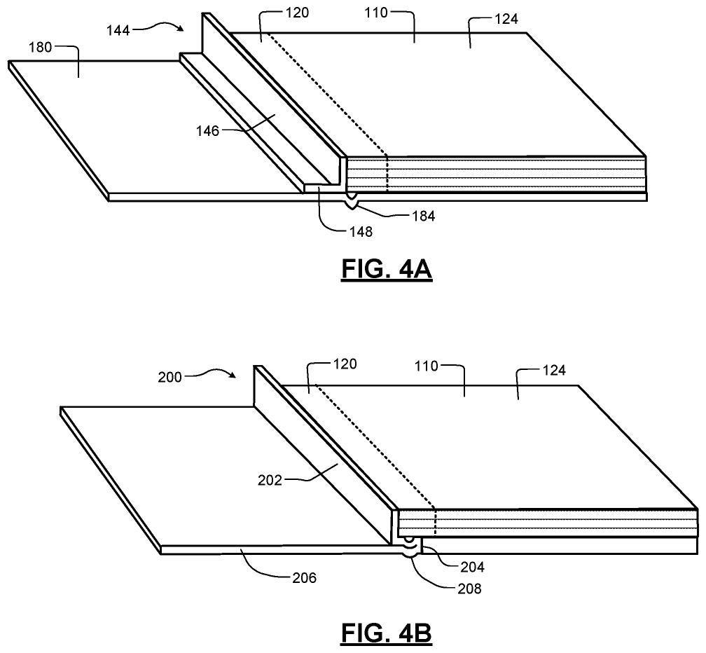

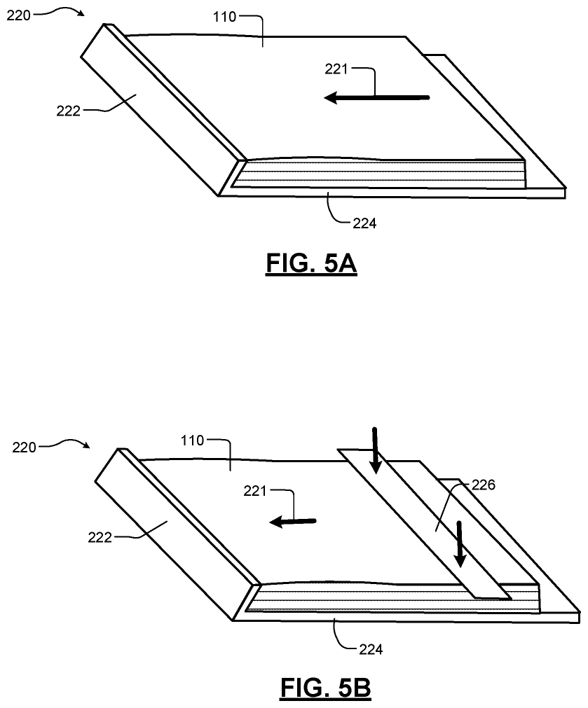

Referring now to FIGS. 4A to 4B, a gas relief channel can be used to release weld gases generated during laser welding. In some examples, the gas relief channel includes a concave channel extending below the internal terminal and/or the external tabs to allow weld gases to escape during laser welding. In FIG. 4A, the internal terminal 144 of FIG. 3A is welded to the external tabs 120 of the stack 110. A supporting surface 180 includes a gas relief channel 184 arranged below the external tabs 120 adjacent to the outer surface of the first portion 146.

In FIG. 4B, an internal terminal 200 includes a first portion 202, a second portion 204, and a third portion 206 (e.g., similar to FIG. 3B). The second portion 204 further includes a gas relief channel 208 arranged below the external tabs 120 adjacent to the outer surface of the first portion 202.

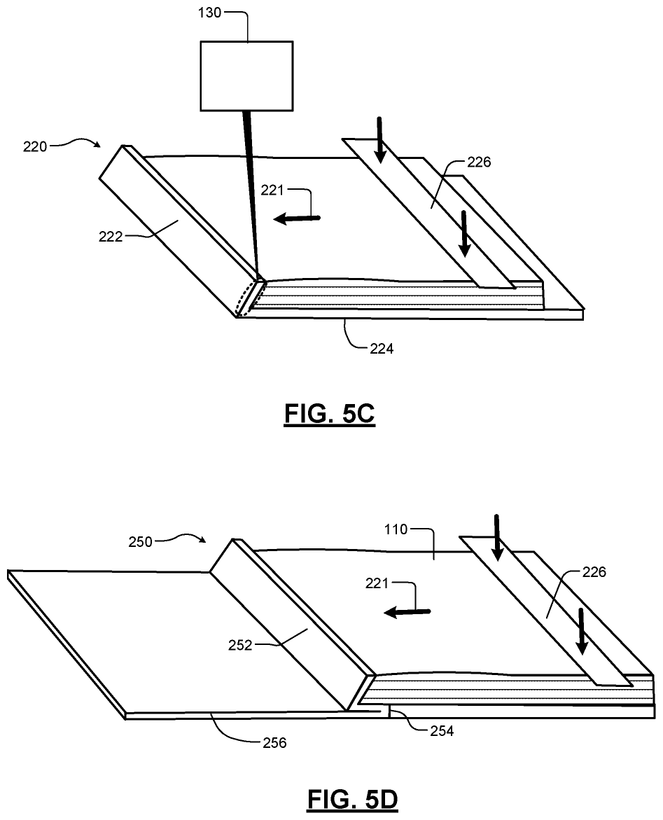

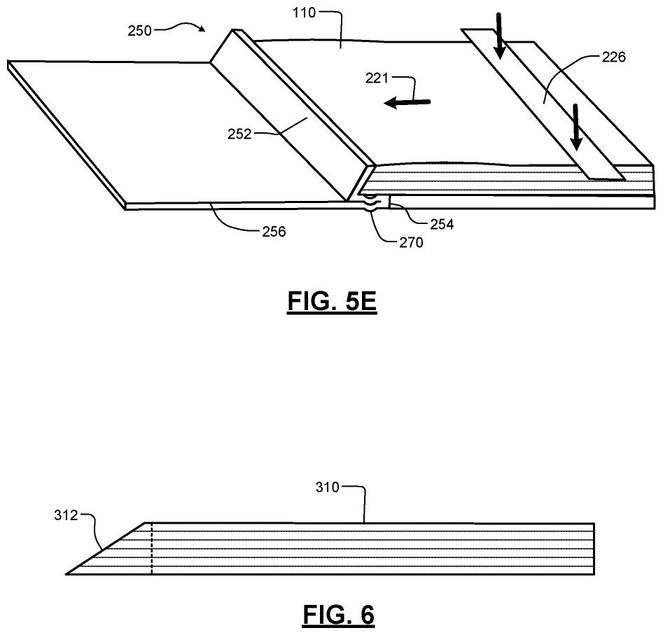

Referring now to FIGS. 5A to 5E, an internal terminal 220 includes a first portion 222 forming an acute angle relative to a second portion 224. In some examples, the acute angle is in a predetermined range between 15° and 75°. In some examples, the acute angle is in a predetermined range between 35° and 55° (e.g., 45°). In FIG. 5A, the stack 110 is arranged on the second portion 224 and laterally pressed against an inner surface of the first portion 222 as shown by arrow 221. The lateral pressure against the stack 110 against the first portion 202 causes the electrodes that are higher in the stack to bend and create space between layers of the stack. The excess length of the upper electrodes layers compensates for weld shrinkage. The space that is created between the upper electrode layers of the stack also provides a path for weld gases to escape during laser welding. Alternately a gas relief channel can be created in the second portion of the internal terminal and/or on a supporting surface.

In some examples, a clamp 226 may be used to apply pressure against the stack 110 after applying the lateral pressure to hold the stack against the internal terminal during laser welding as shown in FIGS. 5B and 5C.

In FIG. 5D, an internal terminal 250 includes a first portion 252, a second portion 254, and a third portion 256 (e.g., similar to FIG. 3B). In some examples, the first portion 252 is attached to the second portion 254 at a predetermined angle in a range from 15° to 75°. In other examples, the predetermined angle is in a range from 35° to 55° (e.g., 45°). The second portion 254 is folded back upon itself to create a “U”-shape with a minimal gap or no gap between sides thereof. One end of the second portion 254 extends from the first portion 252. The third portion 256 extends from the second portion 254. The longitudinal length of the third portion 256 can be longer or shorter than a length of the stack 110. In some examples, the stack 110 can be arranged on the supporting surface 157 during laser welding.

In FIG. 5E, the second portion 254 of the internal terminal 250 includes a gas relief channel 270 arranged below the external tabs 120 adjacent to the outer surface of the first portion 202.

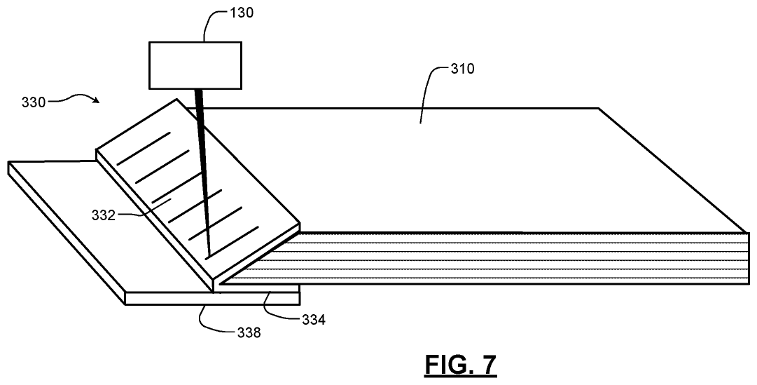

Referring now to FIG. 6, a stack 310 includes anode electrodes or cathode electrodes with external tabs 312 extending from corresponding current collectors. The external tabs 312 are trimmed at an acute angle at one end. In some examples, the external tabs 312 are trimmed at approximately the same acute angle as the angle formed between the first portion and the second portion of the internal terminal. As used herein, approximately the same acute angle means within +/−5° or +/−10°.

Referring now to FIG. 7, an internal terminal 330 includes a first portion 332 and a second portion 334. In some examples, the internal terminal 330 and/or the stack 110 are arranged on a supporting surface 338. The first portion 332 forms an acute angle relative to the second portion 334. The stack 310 includes the external tabs 312 that are trimmed at an acute angle. The laser 130 welds the external tabs 312 to the first portion 332 through the first portion 332.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a battery cell, comprising:
providing a stack including:
C cathode electrodes each including a cathode current collector, a cathode active layer arranged on the cathode current collector, and an external tab extending from the cathode current collector;
A anode electrodes including an anode current collector, an anode active layer arranged on the anode current collector, and an external tab extending from the anode current collector; and
S separators, where C, S and A are integers greater than one; and
providing a terminal including a first portion connected to a second portion at a predetermined angle less than or equal to 100°;
positioning external tabs of one of the A anode electrodes and the C cathode electrodes in contact with one of an inner surface and an outer surface of the first portion of the terminal; and
laser welding ends of the external tabs to the one of an inner surface and an outer surface of the first portion of the terminal.

2. The method of claim 1, wherein the predetermined angle is in a range from 80° to 100°.

3. The method of claim 1, wherein the predetermined angle is in a range from 15° to 75°.

4. The method of claim 1, wherein the predetermined angle is in a range from 35° to 55°.

5. The method of claim 1, wherein the first portion of the terminal has a height that is greater than or equal to a height of the stack.

6. The method of claim 1, further comprising:
arranging a gas relief channel on one of the second portion and a supporting surface arranged below the stack and the terminal,
wherein the gas relief channel is arranged below the external tabs of the one of the A anode electrodes and the C cathode electrodes.

7. The method of claim 1, wherein the external tabs of the one of the A anode electrodes and the C cathode electrodes are laser welded to an outer surface of the terminal.

8. The method of claim 1, wherein the external tabs of the one of the A anode electrodes and the C cathode electrodes are laser welded to an inner surface of the terminal.

9. The method of claim 1, wherein:
the second portion is “U”-shaped, and
the terminal further includes a third portion extending from the second portion.

10. The method of claim 9, wherein the second portion includes a gas relief channel.

11. The method of claim 1, further comprising cutting the external tabs of the one of the A anode electrodes and the C cathode electrodes at a predetermined angle prior to laser welding.

12. The method of claim 11, wherein the predetermined angle is within +/−10° of an angle formed between the first portion and the second portion of the terminal.

13. The method of claim 11, wherein the laser welding is performed through the first portion of the terminal.

14. The method of claim 1, wherein the laser welding forms a butt weld between the terminal and the external tabs of the one of the A anode electrodes and the C cathode electrodes.

15. The method of claim 1, further comprising pressing the external tabs of the one of the A anode electrodes and the C cathode electrodes against the terminal prior to laser welding.

16. The method of claim 1, further comprising pressing the external tabs of the one of the A anode electrodes and the C cathode electrodes against the terminal and clamping the stack to at least one of the terminal and a supporting surface during laser welding.

17. A battery cell comprising:
a stack including:
C cathode electrodes each including a cathode current collector, a cathode active layer arranged on the cathode current collector, and an external tab extending from the cathode current collector;
A anode electrodes including an anode current collector, an anode active layer arranged on the anode current collector, and an external tab extending from the anode current collector; and
S separators, where C, S and A are integers greater than one; and
a terminal including a first portion connected to a second portion at a predetermined angle less than or equal to 100°,
wherein the external tabs of one of the A anode electrodes and the C cathode electrodes are laser welded to one of an inner surface and an outer surface of the first portion of the terminal.

18. The battery cell of claim 17, wherein the predetermined angle is in a range from 15° to 100°.

19. The battery cell of claim 17, further comprising:
a gas relief channel arranged on the second portion,
wherein the gas relief channel is arranged below the external tabs of the one of the A anode electrodes and the C cathode electrodes.

20. The battery cell of claim 17, wherein:
the external tabs of the one of the A anode electrodes and the C cathode electrodes are cut at a predetermined angle, and
the predetermined angle is within +/−10° of an angle formed between the first portion and the second portion of the terminal.
